(19) United States
(12) Patent Application Publication
(10) Pub. No.: US 2007/0283848 A1
(43) Pub. Date: Dec. 13, 2007

(54) Metal ink composition for inkjet printing

(75) Inventors: Tae-Hoon Kim, Yongin-si (KR); Jae-Woo Joung, Suwon-si (KR); Sung-Nam Cho, Suwon-si (KR); Sung-Il Oh, Seoul (KR); Hye-Jin Cho, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/797,631

(22) Filed: May 4, 2007

(30) Foreign Application Priority Data
Jun. 8, 2006 (KR) 10-2006-0051246

(51) Int. Cl. C09D 11/02

(52) U.S. Cl. 106/31.92

(57) ABSTRACT

The present invention relates to a metal ink composition for inkjet printing, more particularly to a metal ink composition which includes 20 to 85 weight % of metal nanoparticles and 15 to 80 weight % of organic solvent, where the organic solvent is made of an ethylene glycol-based ether or a mixed solvent including an ethylene glycol-based ether. The invention provides a metal ink composition in which an organic solvent suited for an inkjet head is used to improve the ejection, storage, and viscosity properties of the ink.

### CROSS-REFERENCE TO RELATED APPLICATIONS

This application claims the benefit of Korean Patent Application No. 10-2006-0051246 filed with the Korean Office on Jun. 8, 2006, the disclosure of which is incorporated herein by reference in its entirety.

### BACKGROUND OF THE INVENTION

1. Field of the Invention

The present invention relates to a metal ink composition for inkjet printing, more particularly to a metal ink composition for inkjet printing having a high concentration of metal, in which an organic solvent suited for an inkjet head is used to improve the ejection, storage, and viscosity properties of the ink.

2. Description of the Related Art

Interest in metal ink is growing in recent times, leading to active research in metal inks. Metal inks currently available in the market may be divided into water-based metal inks, oil-based metal inks, and solvent-based inks. In manufacturing high concentration ink, water-based inks yield larger nanoparticle sizes and higher viscosity compared to oil-based metal inks, causing difficulties in continuous ejection at the inkjet head. Thus, adjustments are required in the manufacture of high concentration metal ink, which allow continuous ejection of inkjet ink even with high metal content.

Conventional methods have used water-based metal nanoparticles and hydrophilic solvents, with water and ethanol as the main solvents, to develop ink which does not dry at the inkjet head and which provides desirable surface images at the surface. In the development of such high concentration nano metal inks, the compositions of the inks are determined through numerous preparation experiments, and these compositions are accumulated as important know-how in a corporation. As an example of a water-based ink, an inkjet ink has been developed and publicized in which the content of Ag-IJ-G-100-S1 is as high as 20 weight %. This ink uses ethanol and ethylene glycol as solvents, and is an inkjet ink that can be ejected at an inkjet head. However, in spite of its low metal content, it does not ensure stability in ejection.

### SUMMARY

An aspect of the present invention is to provide a metal ink composition having an increased metal content while maintaining a low viscosity such that provides superb ejection stability and enhances storage stability, when manufacturing an ink composition for inkjet printing using nanoparticles synthesized in a water base.

An aspect of the invention provides a metal ink composition which includes 20 to 85 weight % of metal nanoparticles and 15 to 80 weight % of organic solvent, where the organic solvent is made of an ethylene glycol-based ether or a mixed solvent including an ethylene glycol-based ether.

In certain embodiments, the ethylene glycol-based ether may be one or more selected from a group consisting of triethyleneglycol dimethyl ether, triethyleneglycol monobutyl ether, triethyleneglycol monoethyl ether, diethyleneglycol diethyl ether, diethyleneglycol monobutyl ether, diethyleneglycol dibutyl ether, ethyleneglycol monopropyl ether, and dipropyleneglycol methyl ether.

Here, the ethylene glycol-based ether may be 50 to 100 weight % of the overall organic solvent.

The metal ink composition according to an embodiment of the invention may also further include one or more solvents of water and C1-C8 lower-hydric alcohols.

In certain embodiments, the lower-hydric alcohol may be one or more selected from a group consisting of ethanol, methanol, propanol, isopropanol, 1-butanol, 2-butanol, isobutanol, hexanol, and octanol.

Here, the content of the solvents may be 0 to 50 weight % of the overall organic solvent.

The metal nanoparticles used in certain embodiments of the invention may be nanoparticles of one or more metals selected from a group consisting of silver (Ag), gold (Au), copper (Cu), nickel (Ni), palladium (Pd), platinum (Pt), and alloys thereof. The metal nanoparticles may have a particle size of 50 nm or less.

In certain embodiments, the metal nanoparticles may be capped with one or more dispersants selected from a group consisting of poly(vinyl pyrrolidone) (PVP), polyacids, and derivatives thereof.

Here, the polyacids may include one or more selected from poly(acrylic acid), poly(maleic acid), poly(methyl methacrylate), poly(acrylic acid-co-methacrylic acid), poly(maleic acid-co-acrylic acid), and poly(acrylamide-co-acrylic acid), and the derivatives include one or more selected from a group consisting of a sodium salt, potassium salt, and ammonium salt of the polyacid.

Using such organic solvents, the metal nanoparticles may be included in a high concentration range of 60 to 80 weight % of the overall composition.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a graph representing changes in viscosity in the ink composition with respect to the content of metal nanoparticles, for a metal ink composition according to an embodiment of the invention,

FIG. 2 is an SEM image of silver nanoparticles used in examples and comparative examples of the invention, and

FIG. 3 is a drawing of the printed images of a printed circuit pattern formed using a metal ink composition according to an embodiment of the invention.

### DETAILED DESCRIPTION

The metal ink composition according to certain aspects of the invention will be described below in more detail.

When a water-based solvent is used in a metal ink for inkjet printing, the size of the metal nanoparticles is larger compared to the case of using oil-based solvents, and the viscosity is higher when the ink is manufactured to have a high concentration. In order to manufacture an ink that allows continuous ejection at the inkjet head, a solvent is required with which excellent ejection and flow properties may be achieved at the inkjet head with just the solvent. Thus, an aspect of the invention is to optimize the composition of the metal ink such that the viscosity is decreased while the metal content is maintained at a high concentration, for enhanced ejection and storage properties of the metal ink.

The organic solvent forming the metal ink composition according to certain embodiments of the invention is made of an ethylene glycol-based ether or a mixed solvent including an ethylene glycol-based ether.

An ethylene glycol-based ether can stabilize metal nanoparticles, by means of the ether group which contains an unshared electron pair, to allow the melting of metal nanoparticles to high concentrations without additional dispersants. Moreover, the ethylene glycol-based ether has a high boiling point of over 100° C., such that a suitable viscosity can be maintained at the inkjet head, when forming wiring using inkjet printing, for enhanced ejection stability.

Specific examples of the ethylene glycol-based ether include, but are not limited to, triethyleneglycol dimethyl ether, triethyleneglycol monobutyl ether, triethyleneglycol monoethyl ether, diethyleneglycol diethyl ether, diethyleneglycol monobutyl ether, diethyleneglycol dibutyl ether, ethyleneglycol monopropyl ether, and dipropyleneglycol methyl ether, etc.

In certain embodiments, one of these ethylene glycol-based ethers may be used by itself, or two or more may be used as a mixture. When two or more ethylene glycol-based ethers are mixed together and used as the organic solvent, the mixture may be considered of an ethylene glycol-based ether having a boiling point of 200° C. or higher and a flash point of 100° C. or higher with an ethylene glycol-based ether having a boiling point lower than 200° C. and a flash point lower than 100° C., so that the drying rate may be adjusted to an appropriate level when forming wiring.

Among the specific examples listed above, ethylene glycol-based ethers having boiling points of 200° C. or higher and flash points of 100° C. or higher include diethyleneglycol diethyl ether, ethyleneglycol monopropyl ether, and dipropyleneglycol methyl ether, etc., while ethylene glycol-based ethers having boiling points lower than 200° C. and flash points lower than 100° C. include triethyleneglycol dimethyl ether, triethyleneglycol monobutyl ether, triethyleneglycol monoethyl ether, diethyleneglycol monobutyl ether, and diethyleneglycol dibutyl ether, etc.

The ethylene glycol-based ether may be contained to be 50 to 100 weight % of the overall organic solvent. If the content of the ethylene glycol-based ether is less than 50 weight %, the drying rate of the nozzle may become too rapid, making the ejection unstable and making it difficult for inkjet drops to form, whereby the use of additional drying agents having high boiling point is made necessary to prevent the drying of the nozzle.

The metal ink composition of an embodiment of the invention may also further include one or more solvents of water and C1-C8 lower-hydric alcohols. Water can be used to adjust viscosity by adjusting the surface tension of the ink composition, and lower-hydric alcohols can be used to adjust the drying rate when forming wiring. To be more specific, the lower-hydric alcohols may be ethanol, methanol, propanol, isopropanol, 1-butanol, 2-butanol, isobutanol, hexanol, and octanol, etc. Here, the content of the solvents may be 0 to 50 weight % of the overall organic solvent. The solvents are used as drying accelerators, for adjusting the drying rate on the desired substrate. If the content of the solvents exceeds 50 weight %, the excessively rapid drying may affect ejection.

In a metal ink composition of an embodiment of the invention, although the metal used for forming metal nanoparticles is not particularly limited, one or more selected from silver (Ag), gold (Au), copper (Cu), nickel (Ni), palladium (Pd), platinum (Pt), and alloys thereof may be used. The smaller the particle size of the metal nanoparticles, the easier the ejection, and while it is possible to use particles of 200 nm or smaller, particles of 50 nm or smaller may provide better results for inkjet ejection.

In certain embodiments, the metal nanoparticles may be capped with one or more dispersants selected from a group consisting of poly(vinyl pyrrolidone) (PVP), polyacids, and derivatives thereof.

Here, the polyacid may be a polymer that includes a carboxyl group or a derivative thereof in the main chain or side chain and has a degree of polymerization of 10 to 100,000. Specific examples of such a polyacid include, but are not limited to, poly(acrylic acid), poly(maleic acid), poly(methyl methacrylate), poly(acrylic acid-co-methacrylic acid), poly(maleic acid-co-acrylic acid), and poly(acrylamide-co-acrylic acid), etc.

In addition, the derivatives of the polyacid refer to chemical compounds in which the hydrogen atom of a carboxyl group is substituted by another atom or molecule, such as the sodium salts, potassium salts, and ammonium salts, etc., of the polyacid.

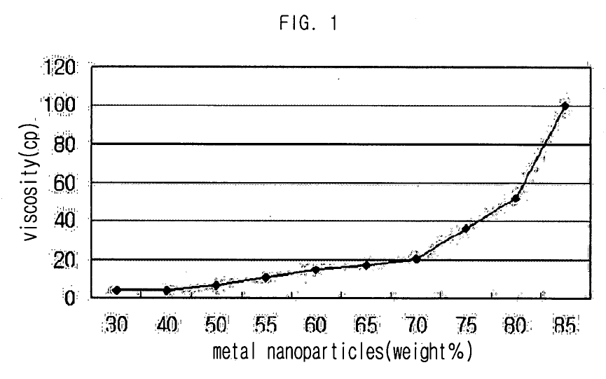

Meanwhile, while preparing metal nanoparticles using ethyleneglycol monopropyl ether as the organic solvent, changes in viscosity with respect to metal nanoparticle content were measured, which are shown in FIG. 1. As seen in FIG. 1, it was observed that the metal ink composition according to certain embodiments of the invention could be prepared to have a content of up to 85 weight %, and that continuous ejection was possible with a high metal content of 70 weight % or higher. Also, ejection was possible with a viscosity of 20 cp or lower for a typical inkjet head using MEMS technology (Spectra corporation), and good ejection was provided with a viscosity of 40 cp or lower for an inkjet head made of a glass material (Microfab corporation).

As such, a metal ink composition according to an embodiment of the invention may contain metal nanoparticles of 20 to 85 weight % of the overall composition. When the content is below 20 weight %, the metal content may be insufficient, in which case the utility of the metal ink in wiring applications will lack variety and its use will be limited, whereas when the content is over 85 weight %, the viscosity may be too high, such that the ejection property of the ink may be degraded, to be undesirable for use as a metal ink.

Furthermore, the content of the organic solvent may be 15 to 80 weight % of the overall composition. When the content is below 15 weight %, the same results occur as when the metal nanoparticles exceed 85 weight %, and when the content is over 80 weight %, the same results occur as when the metal nanoparticles is less than 20 weight %.

Experimental examples of the invention will be described below in more detail, the intended purpose of which is to be illustrative, not to limit the invention.

### EXPERIMENTAL EXAMPLES 1˜14

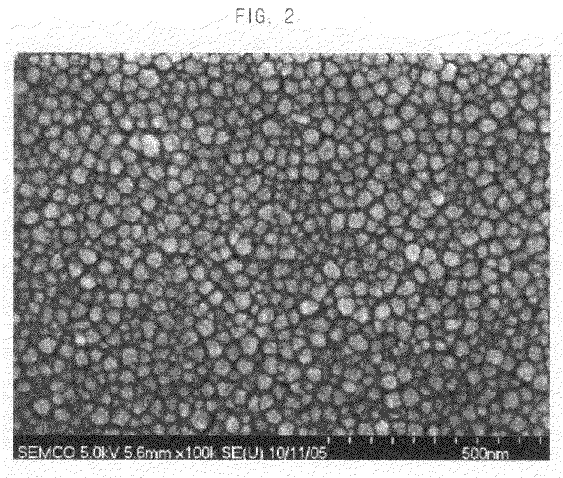

Metal ink compositions were manufactured by mixing 40 weight % of an organic solvent and 60 weight % of silver nanoparticles, where the organic solvent was prepared by mixing each solvent according to the contents listed below in Table 1. The silver nanoparticles used here were nanoparticles that had particle sizes of less than 50 nm and were capped with PVP, which had been manufactured by a method disclosed in Korean Patent Application No. 10-2005-085708. An SEM image of the silver nanoparticles used in the Experimental Examples and Comparative Examples is shown in FIG. 2.

To evaluate the ejection properties of the manufactured ink compositions, inkjet ejection tests were performed using the Se-128 head from Spectra corporation, the results of which are also listed below in Table 1. Here, “printing after resting” refers to the resting time after stopping the printing and halting the machinery until restarting the printing of images, while “continuous printing” refers to the duration for which the images may be continuously printed without cleaning the head, etc.

### COMPARATIVE EXAMPLES 1˜2

Except that the ink (Ag-IJ-G-100-S1) of the Cabot corporation of the United States was used as the organic solvent, the metal ink compositions were manufactured by the same procedures as those for the Experimental Examples above, and the results measured for the ejection properties of the manufactured compositions are listed below in Table 1.

The Cabot corporation ink (Ag-IJ-G-100-S1) uses ethanol as the main solvent and ethyleneglycol as an auxiliary solvent.

TABLE 1

| | triethylene- | triethylene- | triethylene- | diethylene- | diethylene- | | dipropylene- | | | |
|---|---|---|---|---|---|---|---|---|---|---|
| | glycol | glycol | glycol | glycol | glycol | ethyleneglycol | glycol | | printing | |
| | dimethyl | monobutyl | monoethyl | butyl | dibutyl | monopropyl | methyl | | after | continuous. |
| | ether | ether | ether | ether | ether | ether | ether | ethanol | resting | printing |
| Experimental | 100% | | | | | | | | 2 hrs | 5 hrs |
| Example 1 | | | | | | | | | or more | or more |
| Experimental | | | | 90% | | | | 10% | 2 hrs | 5 hrs |
| Example 2 | | | | | | | | | or more | or more |
| Experimental | | | 100% | | | | | | 2 hrs | 5 hrs |
| Example 3 | | | | | | | | | or more | or more |
| Experimental | | 100% | | | | | | | 2 hrs | 5 hrs |
| Example 4 | | | | | | | | | or more | or more |
| Experimental | | | | 50% | | 30% | 20% | | 1 hr | 5 hrs |
| Example 5 | | | | | | | | | or more | or more |
| Experimental | | | 80% | | | 10% | 10% | | 1 hr | 5 hrs |
| Example 6 | | | | | | | | | or more | or more |
| Experimental | | 90% | | | | 10 wt % | | | 1 hr | 5 hrs |
| Example 7 | | | | | | | | | or more | or more |
| Experimental | | | | 90% | | | 10% | | 1 hr | 5 hrs |
| Example 8 | | | | | | | | | or more | or more |
| Experimental | 90% | | | | | | 10% | | 1 hr | 5 hrs |
| Example 9 | | | | | | | | | or more | or more |
| Experimental | 90% | | | | | 10% | | | 1 hr | 5 hrs |
| Example 10 | | | | | | | | | or more | or more |
| Experimental | | | | | 100% | | | | 1 hr | 5 hrs |
| Example 11 | | | | | | | | | or more | or more |
| Experimental | | | | | 90% | 10% | | | 1 hr | 5 hrs |
| Example 12 | | | | | | | | | or more | or more |
| Experimental | | | | | 50% | 50% | | | 1 hr | 5 hrs |
| Example 13 | | | | | 50% | 50% | | | or more | or more |
| Experimental | | | | | | | 90% | 10% | 30 mins | 5 hrs |
| Example 14 | | | | | | | | | or more | or more |

| | | | |
|---|---|---|---|
| Comparative | Cabot Ink with 20 weight % metal (Cabot Corporation Ag-IJ-G-100-S1) | 10 mins | 1 hr |
| Example 1 | | or more | or more |
| Comparative | Cabot Ink with 50 weight % metal (Cabot Corporation, Ag-IJ-G-100-S1) | 2 mins | 10 mins |
| Example 2 | | or more | or more |

(unit: weight %)

From the results of Table 1, it is seen that the metal ink compositions based on certain embodiments of the invention have been significantly improved, as they provide times of one hour or more for the continuous printing and printing after resting, even while containing high concentrations of metal nanoparticles. Moreover, in the case of conventional water-based solvents, not only was the ejection property poor, but also blockage would occur in the head during the course of the print images being transmitted to the printing system, to render ejection impossible, or drying would occur in the head during the printing of the images, to be unable to provide good images.

Also, to measure the thermal stabilities of the metal ink compositions manufactured in the above Experimental Experiments 1˜14, a three-temperature cycle test was performed, in which each composition was placed under a high-temperature condition of 50° C., normal temperature, and a low-temperature condition of 0° C. for 24 hours. Evaluation was performed with regards the change in granularity, presence of precipitation, and change in viscosity, the results of which are listed below in Table 2.

TABLE 2

| | Change in | Presence of | Change in |
|---|---|---|---|
| | Granularity | Precipitation | Viscosity |
| Experimental | ◯ | X | ⊚ |
| Example 1 | | | |
| Experimental | ⊚ | X | ⊚ |
| Example 2 | | | |
| Experimental | ⊚ | X | ⊚ |
| Example 3 | | | |
| Experimental | ◯ | X | ⊚ |
| Example 4 | | | |
| Experimental | ◯ | X | ⊚ |
| Example 5 | | | |
| Experimental | ⊚ | X | ⊚ |
| Example 6 | | | |
| Experimental | ⊚ | X | ⊚ |
| Example 7 | | | |
| Experimental | ⊚ | X | ⊚ |
| Example 8 | | | |
| Experimental | ⊚ | X | ⊚ |
| Example 9 | | | |
| Experimental | ⊚ | X | ⊚ |
| Example 10 | | | |
| Experimental | ⊚ | X | ⊚ |
| Example 11 | | | |
| Experimental | ⊚ | X | ⊚ |
| Example 12 | | | |
| Experimental | ◯ | X | ⊚ |
| Example 13 | | | |
| Experimental | ⊚ | X | ⊚ |
| Example 14 | | | |

* Evaluation Criteria
a) Change in Granularity: ⊚ less than 10%, ◯ less than 20%, Δ less than 30%
b) Change in Viscosity: ⊚ less than 10%, ◯ less than 20%, Δ less than 30%
c) Presence of Precipitation: ◯ present, X absent

From the results of Table 2, it is seen that the metal ink compositions based on certain embodiments of the invention have superb thermal stability, even while containing high concentrations of metal nanoparticles of 50 weight % or higher.

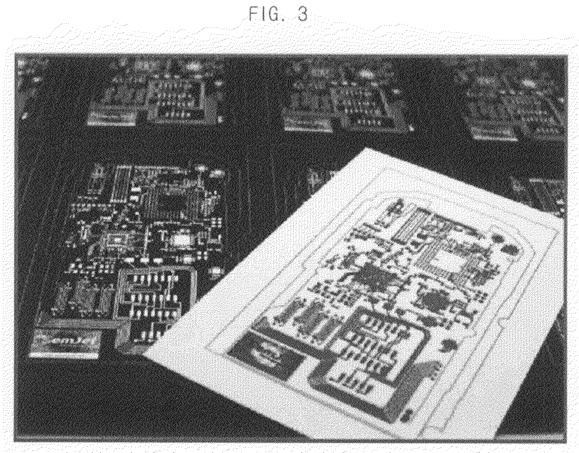

A printed circuit pattern formed using a metal ink composition according to an embodiment of the invention is shown in FIG. 3. Referring to FIG. 3, it is noted that the metal ink composition according to an embodiment of the invention has excellent ejection properties so that the printed image is high in clarity.

As set forth above, a metal ink composition according to an aspect of the invention uses an ethylene glycol-based ether as an organic solvent to maintain a low viscosity at the inkjet head while containing a high concentration of metal nanoparticles, for excellent ejection stability and superb storage stability.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A metal ink composition comprising:
20 to 85 weight % of metal nanoparticles; and
15 to 80 weight % of organic solvent,
the organic solvent being made of an ethylene glycol-based ether or a mixed solvent including an ethylene glycol-based ether.

2. The metal ink composition of claim 1, wherein the ethylene glycol-based ether is one or more selected from a group consisting of triethyleneglycol dimethyl ether, triethyleneglycol monobutyl ether, triethyleneglycol monoethyl ether, diethyleneglycol diethyl ether, diethyleneglycol monobutyl ether, diethyleneglycol dibutyl ether, ethyleneglycol monopropyl ether, and dipropyleneglycol methyl ether.

3. The metal ink composition of claim 1, wherein the ethylene glycol-based ether forms 50 to 100 weight % of the overall organic solvent.

4. The metal ink composition of claim 1, further comprising one or more solvents of water and C1-C8 lower-hydric alcohols.

5. The metal ink composition of claim 4, wherein the lower-hydric alcohol is one or more selected from a group consisting of ethanol, methanol, propanol, isopropanol, 1-butanol, 2-butanol, isobutanol, hexanol, and octanol.

6. The metal ink composition of claim 4, wherein the solvents form 0 to 50 weight % of the overall organic solvent.

7. The metal ink composition of claim 1, wherein the metal nanoparticles are nanoparticles of one or more metals selected from a group consisting of silver (Ag), gold (Au), copper (Cu), nickel (Ni), palladium (Pd), platinum (Pt), and alloys thereof.

8. The metal ink composition of claim 1, wherein the metal nanoparticles have a particle size of 50 nm or less.

9. The metal ink composition of claim 1, wherein the metal nanoparticles are capped with one or more dispersants selected from a group consisting of poly(vinyl pyrrolidone) (PVP), polyacids, and derivatives thereof.

10. The metal ink composition of claim 9, wherein the polyacids include one or more selected from poly(acrylic acid), poly(maleic acid), poly(methyl methacrylate), poly(acrylic acid-co-methacrylic acid), poly(maleic acid-co-acrylic acid), and poly(acrylamide-co-acrylic acid), and the derivatives include one or more selected from a group consisting of a sodium salt, potassium salt, and ammonium salt of the polyacid.

11. The metal ink composition of claim 1, wherein the metal ink composition includes 60 to 80 weight % of the metal nanoparticles.
